(19) United States
(12) Patent Application Publication
(10) Pub. No.: US 2026/0181442 A1
(43) Pub. Date: Jun. 25, 2026

(54) MIMO CSI ENHANCEMENTS FOR DL WTRU AGGREGATION

(71) Applicant: InterDigital Patent Holdings, Inc., Wilmington, DE (US)

(72) Inventors: Loic Canonne-Velasquez, Dorval (CA); Mohammad Irfan, Chateauguay (CA); Afshin Haghighat, Ile-Bizard (CA); Moon IL Lee, Melville, NY (US); Omid Saatlou, Montreal (CA); Jonghyun Park, Syosset, NY (US); Virgil Comsa, Montreal (CA)

(73) Assignee: InterDigital Patent Holdings, Inc., Wilmington, DE (US)

(21) Appl. No.: 18/990,588

(22) Filed: Dec. 20, 2024

(51) Int. Cl. H04W 24/10; H04B 7/06; H04L 5/00; H04W 72/1273

(52) U.S. Cl. CPC H04W 24/10; H04B 7/0626; H04L 5/0048; H04W 72/1273

(57) ABSTRACT

A WTRU may transmit a first set of capabilities associated with the WTRU and a second set of capabilities associated with a second WTRU. The WTRU may receive a reference signal (RS) configuration that indicates one or more RS parameters for reception, and may receive the RS. The WTRU may determine an aggregation mode of operation. The WTRU may receive one or more channel state information (CSI) reporting configurations that are associated with one or more sub-configurations. The WTRU may select a CSI reporting sub-configuration. The WTRU may transmit a CSI report according to the selected CSI reporting sub-configuration, where the CSI report may include an indication of one or more indexes associated with the selected sub-configuration and an index of at least one of the first set of capabilities and the second set of capabilities.

### BACKGROUND

In NR, the current CSI reporting procedures are based on a single WTRU's link with one or more TRPs, which may only depend on the reported capabilities of the served WTRU. However, in an aggregated mode, an Anchor WTRU can enhance its capabilities by utilizing an Assistant WTRU. The current CSI reporting procedures are not sufficient to let the Anchor WTRU report CSI with different aggregated mode capabilities. Solutions may be needed to describe how the Anchor WTRU indicates and reports CSI for aggregated operation to assist the network scheduling and/or to describe the fallback behavior for the Anchor WTRU between the different aggregation modes of operation.

### SUMMARY

Systems, methods, and instrumentalities for multiple-input/multiple-output (MIMO) channel state information (CSI) enhancements for downlink (DL) WTRU aggregation may be disclosed herein. One or more of the methods disclosed herein may be implemented by a wireless transmit/receive unit (WTRU) and/or a UE, for example via a processor thereof.

A WTRU (e.g., an anchor WTRU) may transmit, to a network (e.g., gNB), a first set of capabilities associated with the WTRU and a second set of capabilities associated with a second WTRU (e.g., an assistant WTRU). The WTRU may receive, from the network, a reference signal (RS) configuration that indicates one or more RS parameters for reception associated with the first set of capabilities and the second set of capabilities. The WTRU may receive the RS based on the received RS parameters. The WTRU may determine, based on the first set of capabilities and the second set of capabilities, an aggregation mode of operation. The WTRU may receive, from the network, one or more channel state information (CSI) reporting configurations, where each CSI reporting configuration may be associated with one or more sub-configurations for aggregated CSI reporting. A (e.g., each) sub-configuration may be associated with at least one of the first set of capabilities and the second set of capabilities, and/or may indicate one or more reporting quantities associated with at least one of the first set of capabilities and the second set of capabilities. The WTRU may receive, from the network, a grant scheduling a physical downlink shared channel (PDSCH) transmission, wherein the grant indicates the determined aggregation mode of operation and a resource allocation associated with the determined aggregation mode of operation.

The WTRU may select, based on the first set of capabilities, the second set of capabilities, and the determined aggregation mode of operation, a CSI reporting sub-configuration. The WTRU may transmit, to the network, a CSI report according to the selected CSI reporting sub-configuration, where the CSI report may include an indication of one or more indexes associated with the selected sub-configuration and an index of at least one of the first set of capabilities and the second set of capabilities.

The WTRU may perform a fallback procedure. For example, the WTRU may select a second aggregation mode of operation (e.g., based on one or more of a channel measurement quality or an aggregation timing threshold). The WTRU may determine a default subset of the one or more sub-configurations and transmit, to the network, a CSI report associated with the default subset. The WTRU may determine a default aggregation reception mode for PDSCH.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example WTRU aggregation scenario.

FIG. 3 illustrates an example of CSI reporting for an aggregated set.

FIG. 4 illustrates an example of a WTRU's fallback procedure for PDSCH reception.

### DETAILED DESCRIPTION

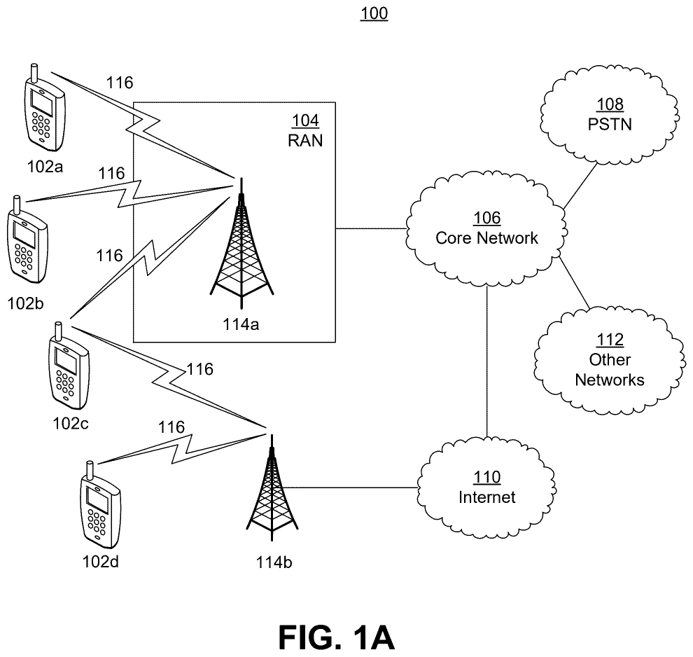

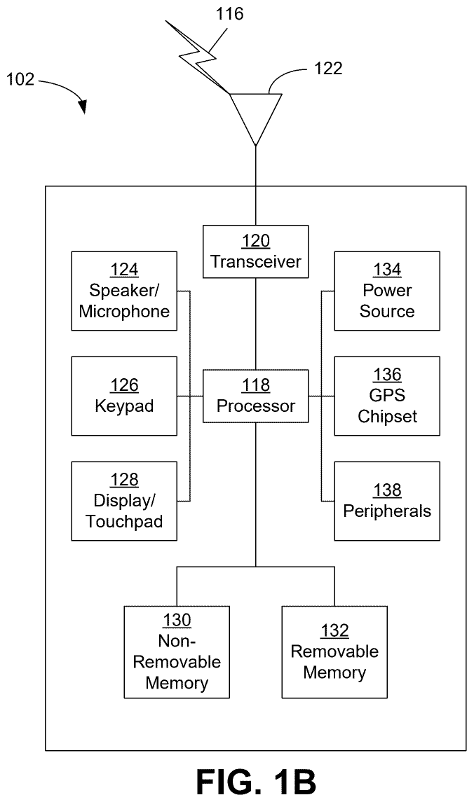

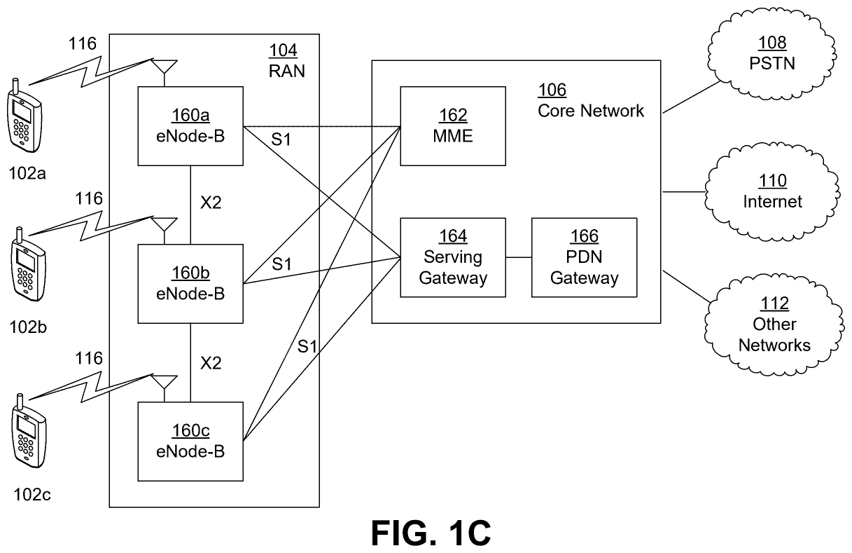

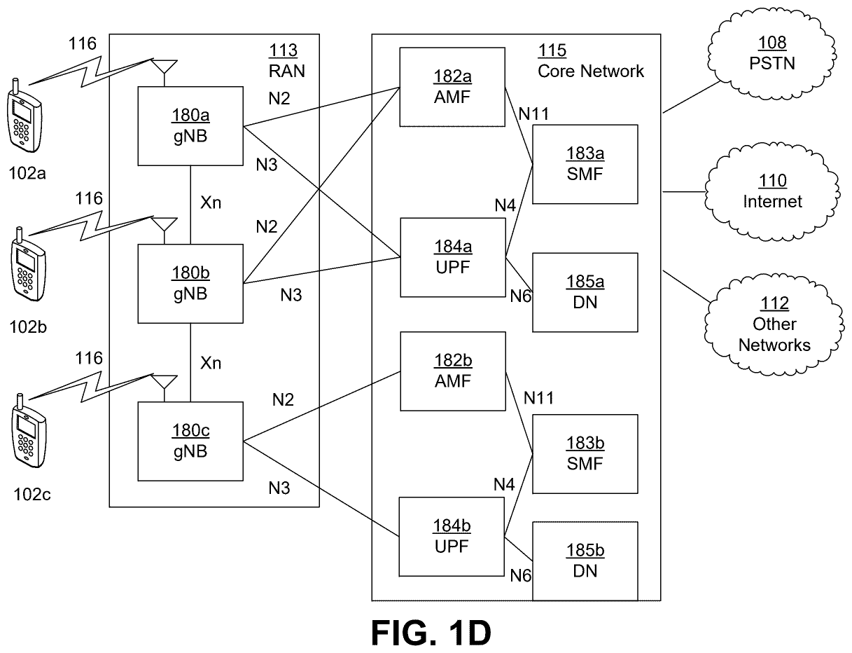

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

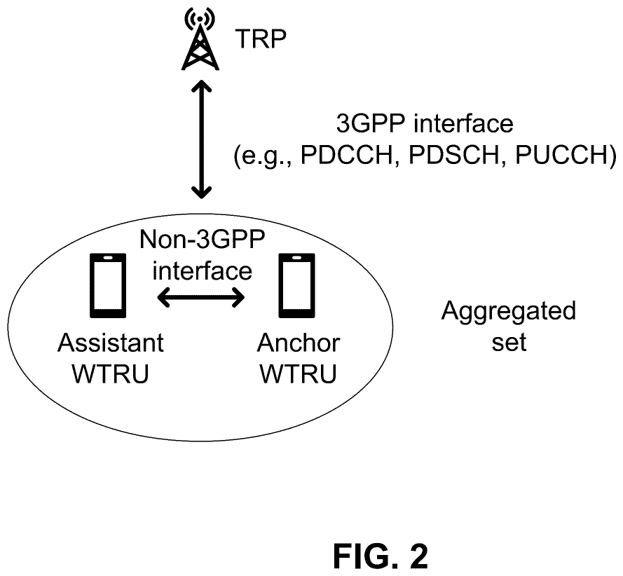

Wireless transmit/receive unit (WTRU) aggregation is a new type of transmission scenario that has been proposed to be studied for Rel-20 and future releases. FIG. 2 illustrates an example WTRU aggregation scenario. FIG. 2 may be considered as an exemplary deployment scenario for WTRU aggregation, where a (e.g., one) TRP is serving an aggregated set comprised of an Anchor WTRU and an Assistant WTRU. The data may be primarily intended for the Anchor WTRU, which may be controlled by the 3GPP interface. The Anchor WTRU may be responsible for monitoring PDCCH, decoding PDSCH, and reporting on PUCCH. The Anchor WTRU may have one or more Assistant devices in its close proximity that it can connect to with better reception capabilities such as CPE, VR headset, watch, glasses, smartphone, tablet, laptop, vehicle, etc.

The network may dynamically switch between different modes of operation through DCI scheduling which is targeted to the Anchor WTRU. For example, if an Anchor WTRU's MIMO reception capability is limited to rank 2, then without aggregation the network may (e.g., only) schedule data transmission with up to rank 2 to the Anchor WTRU. However, if the Anchor WTRU is connected with an Assistant WTRU which also has MIMO reception capability limited to rank 2, with WTRU aggregation the Anchor WTRU can be scheduled with up to rank 4 reception, where a first part of the data is received by the Anchor WTRU, and a second part is received by the Assistant WTRU and forwarded to the Anchor WTRU.

In NR, the current CSI reporting procedures are based on a single WTRU's link with one or more TRPs, which may only depend on the reported capabilities of the served WTRU. However, in an aggregated mode, an Anchor WTRU can enhance its capabilities by utilizing an Assistant WTRU. The current CSI reporting procedures are not sufficient to let the Anchor WTRU report CSI with different aggregated mode capabilities. Solutions may be needed to describe how the Anchor WTRU indicates and reports CSI for aggregated operation to assist the network scheduling and/or to describe the fallback behavior for the Anchor WTRU between the different aggregation modes of operation.

Systems, methods, and instrumentalities for multiple-input/multiple-output (MIMO) channel state information (CSI) enhancements for downlink (DL) WTRU aggregation may be disclosed herein. One or more of the methods disclosed herein may be implemented by a wireless transmit/receive unit (WTRU) and/or a UE, for example via a processor thereof.

A first WTRU (e.g., Anchor WTRU) may report a first set of capabilities (e.g., antennas, PMI codebook, rank) corresponding to the first WTRU, and a second set of capabilities corresponding to a second WTRU (e.g., Assistant WTRU).

The Anchor WTRU may receive a configuration of a reference signal (RS), where the configuration may indicate on or more RS parameters for reception associated with the first and second set of capabilities.

The Anchor WTRU may receive the RS according to the RS reception parameters associated with the first and second set of capabilities to determine an aggregation mode(s) of operation, and the Anchor WTRU may report one or more aggregation modes of operation as a function of the first and second set of capabilities. The one or more aggregation mode(s) of operations may be determined by the Anchor WTRU, and may signal its support of joint reception using the first and second set of capabilities, and/or standalone reception using the first or second set of capabilities.

The Anchor WTRU may receive one or more CSI reporting configurations, where a (e.g., each) may be associated with one or more sub-configurations for aggregated CSI. A (e.g., each) sub-configuration for aggregated CSI reporting may be associated with the first and/or second set of capabilities, and with one or more aggregation mode(s) of operation. A (e.g., each) sub-configuration for aggregated CSI reporting may indicate the one or more reporting quantities (e.g., CRI, RI, PMI, CQI) associated with the first and/or second set of capabilities for a (e.g., each) aggregation mode of operation.

The Anchor WTRU may report one or more CSIs in a CSI report for one or more indicated sub-configurations, where the WTRU may indicate one or more indices associated with the one or more sub-configurations and/or the index of the capability set associated with a (e.g., each) CSI reporting quantity.

The Anchor WTRU may receive a grant scheduling a PDSCH, where the grant may indicate the aggregation mode and the resource allocation corresponding to one of the Anchor WTRU's reported aggregation mode(s).

If the Anchor WTRU determines that its aggregation mode of operation changes, it may perform a fallback procedure where the Anchor WTRU may determine to report CSI for a default subset of the CSI reporting sub-configurations and/or determine a default aggregation reception mode for PDSCH (e.g., TCI). The condition to determine fallback procedure may be based on the Anchor WTRU's channel measurement quality in the aggregated set, or based on an aggregation timing threshold (e.g., DCI-to-PDSCH being less than the threshold).

A WTRU (e.g., anchor WTRU) may report one or more (e.g., two) sets of capabilities (e.g., with and without aggregation). The WTRU may monitor a (e.g., one) RS according to one or more (e.g., two) sets of measurement configurations associated with the sets of capabilities. The WTRU may report different aggregation modes of operation as a function of the RSes and capability sets. The WTRU may be configured with different CSI reporting sub-configurations as a function of the capability sets and aggregation modes. The WTRU may select the CSI reporting sub-configurations to report as a function of the capability sets and aggregation modes. The WTRU may have one or more fallback procedures between different aggregation modes/TCI/CSI reporting sub-configurations.

Hereinafter, “a” and “an” and similar phrases are to be interpreted as “one or more” and “at least one.” Similarly, any term which ends with the suffix “(s)” is to be interpreted as “one or more” and “at least one.” The term “may” is to be interpreted as “may, for example.”

A symbol “/” (e.g., a forward slash) may be used herein to represent “and/or,” where, for example, “A/B” may imply “A and/or B.”

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (e.g., target) physical channel or signal according to a spatial relation with a reference to the second (e.g., reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication.”

The WTRU may receive a first (e.g., target) downlink channel or signal according to the same spatial domain filter or spatial reception parameter as a second (e.g., reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication.”

A grant or an assignment may have one or more properties. Herein, a property of a grant or assignment may consist of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and/or any parameter provided in a DCI, by MAC or by RRC for the scheduling the grant or assignment.

Herein, an indication by DCI may consist of at least one of the following: an explicit indication by a DCI field or by RNTI used to mask CRC of the PDCCH; and/or an implicit indication by a property such as DCI format, DCI size, Coreset or search space, Aggregation Level, first resource element of the received DCI (e.g., index of first Control Channel Element), where the mapping between the property and the value may be signaled by RRC or MAC.

Hereafter, the term TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), consistent with the embodiments disclosed herein. Hereafter, the term Multi-TRP may be interchangeably used with one or more of MTRP, M-TRP, and multiple TRPs, consistent with the embodiments disclosed herein.

A WTRU may report a subset of channel state information (CSI) components, where CSI components may correspond to one or more of a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and/or other channel state information such as at least rank indicator (RI), channel quality indicator (CQI), precoding matrix indicator (PMI), Layer Index (LI), and/or the like.

Herein, a signal may be interchangeably used with one or more of the following: Sounding reference signal (SRS); Channel state information-reference signal (CSI-RS); Demodulation reference signal (DM-RS); Phase tracking reference signal (PT-RS); and/or Synchronization signal block (SSB), consistent with the embodiments disclosed herein.

Herein, the term channel may be interchangeably used with one or more of the following: physical downlink control channel (PDCCH), physical downlink shared channel (PDSCH), Physical uplink control channel (PUCCH), Physical uplink shared channel (PUSCH), Physical random access channel (PRACH), etc., consistent with the embodiments disclosed herein.

Herein, a quantity, report quantity, and/or channel state information (CSI) may be used interchangeably with one or more of the following: Channel Quality Indicator (CQI), Rank Indicator (RI), Precoding Matrix Indicator (PMI), Layer Indicator (LI), CSI reference resource index (CRI), signal to noise and interference ratio (SINR), reference signal received power (RSRP), etc., consistent with the embodiments disclosed herein.

Herein, downlink transmission or downlink reception may be used interchangeably with Rx occasion, PDCCH, PDSCH, SSB reception, consistent with the embodiments disclosed herein.

Herein, uplink transmission or uplink reception may be used interchangeably with Tx occasion, PUCCH, PUSCH, PRACH, SRS transmission, but still consistent with this invention.

Herein, RS may be interchangeably used with one or more of RS resource, RS resource set, RS port and RS port group, consistent with the embodiments disclosed herein.

Herein, RS may be interchangeably used with one or more of SSB, CSI-RS, SRS and DM-RS, consistent with the embodiments disclosed herein.

Herein, time instance or time-unit may be interchangeably used with slot, symbol, subframe, consistent with the embodiments disclosed herein.

Herein, frequency instance or frequency unit may be interchangeably used with subcarrier, resource element (RE), sub-band, band, bandwidth part, consistent with the embodiments disclosed herein.

A WTRU aggregation scenario and the different transmission/reception aggregation modes of operation may be disclosed herein. The WTRU may receive reference signal configurations as described herein to measure and estimate the channel as a function of the different aggregation modes. The WTRU may determine or may be configured to operate in one of the aggregation modes of operation as a function of the WTRU's reported capabilities and channel measurements, as disclosed herein. The CSI reporting configuration to determine the CSI feedback reporting contents based on the RS measurements, and as a function of the different aggregation modes, may be disclosed herein. The WTRU's procedure to report the CSI may be disclosed herein. The WTRU's procedure to receive the PDSCH may be disclosed herein. The fallback procedures that the WTRU may perform may be disclosed herein.

WTRU aggregation may be performed as disclosed herein. FIG. 2 illustrates an exemplary operation of an aggregated device, or aggregated WTRU. As shown in FIG. 2, an aggregated WTRU may comprise an Anchor WTRU (A-WTRU) that is in charge of representation and connection to a network and an Assisting WTRU (S-WTRU). From a communication perspective, the aggregation may be supported in at least one of the following aspects: transmit power domain (e.g., the A-WTRU may use transmission capability of the S-WTRU to increase its total transmission power to enhance coverage and reliability), spatial domain (e.g., the A-WTRU may expand its spatial domain presence by using antennas of the S-WTRU to enhance the capacity and robustness of a transmission or reception), energy domain (e.g., the A-WTRU may extend its battery life by delegating one or more of its receive and transmit functions to the S-WTRU), and/or frequency domain (e.g., the A-WTRU may enhance its access to a wider bandwidth by employing conduction transmission and/or reception by exploiting the frequency range associated with the S-WTRU).

One or more types of aggregation may be disclosed herein. A network deployment as in FIG. 2 may be considered, where a network entity (e.g., gNB, TRP) is serving an A-WTRU that may have one or more S-WTRUs to enhance its performance. An S-WTRU, according to its capability, may support one of the following assisting modes: Type 1 (e.g., enhanced repetition), type 2 (e.g., enhanced transmission), and/or type 3 (e.g., enhanced repetition and transmission.

For type 1 (e.g., enhanced repetition), an A-WTRU may use an S-WTRU to enhance its reception capability. The A-WTRU may increase the reception quality through the diversity reception provided by the additional antennas of the S-WTRU. In another example, a WTRU may enhance A-WTRU reception capability by increasing the effective rank of the downlink channel through employing the antennas of the S-WTRU.

For type 2 (e.g., enhanced transmission), the A-WTRU may use the S-WTRU to enhance its transmission capability. For example, the A-WTRU may increase the transmission power through use of the additional transmitter of the S-WTRU. In another example, the A-WTRU may enhance its transmission capacity by increasing the effective rank of the uplink channel though employing the antennas of the S-WTRU.

For type 3 (e.g., enhanced reception and transmission), the A-WTRU may use an associated S-WTRU to enhance its reception and transmission capabilities through combined use of type 1 and type 2.

Therefore, an aggregated WTRU may be used when the network communicates with an A-WTRU that is limited by its capabilities (e.g., number of antennas, battery or power, form factor, carrier bands), and it may use an S-WTRU to enhance its capabilities for increased throughput, reliability, energy saving. For example, an A-WTRU may be limited to rank 2 because it has (e.g., only) two antennas; however, the assistant WTRU may have two antennas, and thus the aggregated capabilities of Anchor and Assistant WTRU may be up to four antennas for an aggregated rank of up to 4.

Modes of operation for type 1 aggregation may be disclosed herein. In the considered aggregation scenario, an A-WTRU may be connected to the network through 3GPP physical channels which may schedule the A-WTRU for a data transmission (e.g., PDSCH) using a grant (e.g., DCI carried on a PDCCH), and may receive CSI or HARQ feedback from the A-WTRU through a UCI (e.g., PUCCH or PUSCH). The S-WTRU may be connected to the A-WTRU through a non-3GPP interface (e.g., a wire, Bluetooth, Wi-Fi, etc.), and it may act as a relay to forward received information to the A-WTRU. One or more S-WTRUs may be controlled by the A-WTRU, and the group of WTRUs containing a (e.g., one) A-WTRU and multiple S-WTRUs may be defined as an aggregation set. Without loss of generality, one or more of the embodiments herein may be described with one S-WTRU, but may be extended to the case with multiple S-WTRUs.

For the aggregation Type-1, where an A-WTRU uses an S-WTRU to enhance its reception capability, the following modes of operation may be considered: Mode A and/or Mode B.

Mode A may be considered. In this mode of operation, the network may split the scheduled data into one or more (e.g., two) parts, where a (e.g., each) part may be scheduled for one of A-WTRU or S-WTRU. Moreover, the transmission of the two parts may or may not use the same set of time and frequency resources. For Mode A, the following two alternatives may be considered: mode A1 and mode A2. In Mode A1, the data for the A-WTRU and S-WTRU may be independently scheduled. For example, the A-WTRU and S-WTRU may be scheduled through separate DCIs each with their own resource allocation, or one DCI with separate resource allocations for A-WTRU and S-WTRUs. In Mode A2, the data for the Anchor and Assistant WTRU may be jointly scheduled. For example, A-WTRU and S-WTRU may be scheduled through a single DCI with joint resource allocation for Anchor and Assistant WTRU.

Mode B may be considered. In this mode of operation, the network may schedule the same data for both A-WTRU and S-WTRU. However, transmission for (e.g., each of) the A-WTRU and S-WTRU may be based on using a different spatial filter. Moreover, the transmission of the scheduled data may or may not use the same set of time and frequency resources. For Mode B, following two alternatives may be considered: Mode B1 and Mode B2. In Mode B1, the data for the A-WTRU and S-WTRU may be independently scheduled. For example, A-WTRU and S-WTRU may be scheduled through separate DCIs (e.g., each) with their own resource allocation, or one DCI with separate resource allocations for A-WTRU and S-WTRUs. In Mode B2, the data for the A-WTRU and S-WTRU may be jointly scheduled. For example, A-WTRU and S-WTRU may be scheduled through a (e.g., single) DCI with joint resource allocation for A-WTRU and S-WTRU.

RS configuration may be considered. A WTRU may receive an RS configuration and its association with the capability set and/or aggregation mode(s) of operation. The A-WTRU and/or the S-WTRU may receive a semi-static and/or a dynamic (e.g., by RRC, MAC-CE, and/or DCI) configuration(s) and/or indication(s) (e.g., explicit or implicit indications regarding measurement resource (e.g., zero-power (ZP), or non-zero power (NZP) channel state information (CSI) reference signal (RS) (CSI-RS) configuration)) to monitor, determine, or predict the channel between the A-WTRU and the network (e.g., gNB) and/or the channel between the S-WTRU and the gNB.

The WTRU may receive a scheduling DCI that includes an existing field (e.g., the CSI request field) or a new field (e.g., Aggregated WTRU's CSI request field). Herein, the existing CSI request field or the new aggregated WTRU's CSI request field may be referred to as a CSI request field. The aggregated WTRU's CSI request field may be similar to the existing field. The existing field (e.g., codepoint) may be configured with one or more trigger states, where a (e.g., each) trigger state may be associated with a WTRU (e.g., A-WTRU and/or S-WTRU).

The CSI request field may contain or include an indication that indicates an index or an ID. The index or the ID may be associated with one or more trigger states, for example one or more trigger states configured in the aperiodic TriggerStateList and/or one or more trigger states configured in the aperiodicCSITriggerStateSubselection MAC-CE, where the trigger states in the aperiodicCSITriggerStateSubselection MAC-CE may be a subset of the trigger states in the aperiodic TriggerStateList.

The ID may be an ID associated with a single trigger state in aperiodic TriggerStateList or in aperiodicCSITriggerStateSubselection MAC-CE. The indicated index or the indicated ID may be associated with a single trigger state, meant for the A-WTRU or the S-WTRU. It may be pre-defined or specified that when an ID is associated with a single trigger state, the trigger state is for the S-WTRU or the A-WTRU. Alternatively, the WTRU may receive a semi-static or dynamic indication that indicates that the ID is for the A-WTRU or the S-WTRU. For example, the ID may be for the A-WTRU. The WTRU may receive a DCI with a field (e.g., change request), where the indication associated with the change request field may indicate that the single trigger state indication will be for the S-WTRU, and may also indicate the length of time during which the requested change is valid (e.g., a preconfigured time offset, or an explicitly indicated time offset in the DCI). After the time offset expires, the WTRU may fallback to the trigger state from before the change request, or fallback to a default trigger state indication (e.g., the one for the A-WTRU). Alternatively, the WTRU may assume the changed trigger state until further indication(s) or configuration(s) are received.

The ID may be an ID associated with two or more trigger states in the aperiodic TriggerStateList or in aperiodicCSITriggerStateSubselection MAC-CE. The indicated index or the indicated ID may be associated with two or more trigger states. For example, the aperiodicTriggerStateList may have 4 trigger states, denoted by 1, 2, 3, and 4, and the ID may be associated with the trigger states shown in Table 1:

TABLE 1
An example of a CSI request field indication
associated with two trigger states.

| | | Trigger states |
|---|---|---|
| ID | CSI request field | (S-WTRU, A-WTRU) |
| 0 | 000 | (1, 1) |
| 1 | 001 | (1, 2) |
| 2 | 010 | (1, 3) |
| 3 | 011 | (1, 4) |
| 4 | 100 | (2, 3) |
| 5 | 101 | (2, 4) |
| 6 | 110 | (3, 4) |
| 7 | 111 | Reserved |

A (e.g., each) trigger state may be associated with one or more of the following: a report quantity (e.g., rank indicator, precoding matrix indicator, channel quality indicator, etc.); and/or a codebook configuration and/or codebook parameters. The codebook configuration and/or parameters may include, but are not limited to, one or more of the following: a first Type of a single panel codebook or a first Type of a multi-panel codebook; a second Type of a single panel codebook or a second Type of a multi-panel codebook; a discrete Fourier transform (DFT) oversampling value; a number of CSI-RS antenna ports (e.g., a number of ports when Rel-19 Type-I Scheme-A codebook is configured and/or a number of ports when Rel-19 Type-I Scheme-B codebook is configured); a number of spatial domain basis, time domain basis, and/or Doppler domain basis; one or more frequency domain, time domain, spatial domain compression parameters (e.g., a number of non-zero coefficients in a Type-II CSI report and/or a number of precoders per sub-band); a number of sub-bands; a number of CSI sub-configurations; and/or a number of CSI-RS antenna ports in a CSI sub-configuration).

The WTRU may receive a semi-static or dynamic configuration and/or indications that configures or indicates one or more CSI-RS resource set(s) (e.g., one CSI-RS resource set or two CSI-RS resource sets). A CSI-RS resource set may have one or more CSI-RS resources.

A single CSI-RS resource set may be configured/indicated. A single CSI-RS resource set may be configured for determination of CSI. The CSI-RS resource set may have one or more subset(s) of CSI-RS resources. One or more subsets of CSI-RS resources in the CSI-RS resource set may be for the S-WTRU and/or the A-WTRU. For example, the CSI-RS resource set may have three CSI-RS resources (e.g., CSI-RS1, CSI-RS2, and CSI-RS3). The CSI-RS resource set may have two subsets of CSI-RS resources (e.g., a first of CSI-RS resources that includes CSI-RS1 and CSI-RS3 and a second subset of CSI-RS resources that includes CSI-RS2).

One subset of CSI-RS resources may be for the S-WTRU and another subset of the CSI-RS resources may be for the A-WTRU. For example, the first subset may be for the S-WTRU and the second subset may be for the A-WTRU.

Alternatively, the one or more CSI-RS resources in the CSI-RS resource set may be associated with one or more semi-static or dynamic indications, where a (e.g., each) indication may indicate a subset of CSI-RS antenna ports. CSI-RS antenna ports of a CSI-RS resource indicated using such an indicator may be termed as a sub-configuration. For example, a CSI-RS resource may be configured as a 32 CSI-RS antenna ports resource. The CSI-RS resource may have one or more (e.g., two) associated sub-configurations (e.g., a first sub-configuration and a second sub-configuration). The first sub-configuration may be based on the first 16 CSI-RS antenna ports and the second sub-configuration may be based on the remaining 16 CSI-RS antenna ports. The first sub-configuration may be for the A-WTRU and the second sub-configuration may be for the S-WTRU. For example, the CSI-RS may be the reference signal transmitted by the gNB, and may be used by the WTRU to measure the channel. It may be transmitted across the antenna ports of the gNB, and configured with the number of antenna ports of the gNB. The WTRU may also be configured with sub-configuration(s) which may indicate to the WTRU to measure the channel over a subset of the configured ports (e.g., 16 out of 32).

The CSI-RS resources, CSI-RS resource sets, and/or CSI-RS sub-configurations may be configured with different monitoring parameters, where the monitoring parameters may correspond to any configured parameters for the CSI-RS resource index (e.g., periodicity and/or frequency resources, port indices, power offsets, etc.) to optimize the channel estimation performance, the CSI reporting overhead, and/or the CSI-RS overhead. A (e.g., single) CSI-RS may be configured for the A-WTRU, and the A-WRU and S-WTRU may be configured to monitor different BWP/RBs associated with the same resource index.

Both the A-WTRU and the S-WTRU may be configured to measure CSI-RS resources for CSI determination on one or more bandwidth parts (BWPs) (e.g., BWP1 and BWP2). A first BWP (e.g., BWP1) may include one or more resource blocks (RBs), for example RB1, RB2, . . . , RB10, and a second BWP (e.g., BWP2) may include one or more other RBs, for example RB11, RB12, . . . , RB20.

Both the S-WTRU and the A-WTRU may be configured to determine a CSI in a first BWP (e.g., BWP1). The S-WTRU may be configured to determine a CSI based on odd numbered RBs (e.g., RB1, RB3, . . . , RB9) and the A-WTRU may be configured to determine a CSI based on even numbered RBs (e.g., RB2, RB4, . . . , RB10).

Both the S-WTRU and the A-WTRU may be configured to determine a CSI based on two or more BWPs (e.g., BWP1 and BWP2). The A-WTRU may be configured to measure CSI-RS mapped to the odd numbered RBs on BWP1 and BWP2 and the S-WTRU may be configured to measure CSI-RS mapped to the even numbered RBs on BWP1 and BWP2.

Both the A-WTRU and the S-WTRU may be configured to receive CSI-RS resources, measure CSI-RS resources, and report CSI-RS resources at different periodicities. For example, the S-WTRU may be configured to receive CSI-RS, determine CSI, and report the determined CSI with a first periodicity value, and the A-WTRU may be configured to receive CSI-RS, determine CSI and report the determined CSI with a second periodicity. For example, the A-WTRU may be configured to receive CSI-RS resource(s) every 5 time slots and the S-WTRU may be configured to receive CSI-RS resource(s) every 10 time slots.

Aggregation mode selection may be performed. The A-WTRU may report a first set of capabilities which may include a list of its MIMO reception/transmission parameters for standalone reception (e.g., just A-WTRU or S-WTRU) and a second set of capabilities which may include a list of its MIMO reception/transmission parameters with one or more Assistant WTRUs (e.g., aggregated mode with A-WTRU and S-WTRU). MIMO capabilities may include one or more of: antenna ports, antenna elements, antenna panels, antenna polarization, reference signals (e.g., SRS resource or set index), SRS port groups, precoding codebook (e.g., Type-I, Type-II, etc.), receiver type (e.g., joint or separate). The second set of capabilities may be explicitly indicated by the A-WTRU and/or implicitly indicated by the A-WTRU.

The second set of capabilities may be explicitly indicated by the A-WTRU. For example, the A-WTRU may acquire the S-WTRU's capabilities by requesting the S-WTRU to forward them through the Anchor-Assistant interface, and the A-WTRU may include them in its own capability report transmitted to the network.

The second set of capabilities may be implicitly indicated by the A-WTRU. For example, the A-WTRU may indicate a list of Assistant WTRUs as part of its capabilities (e.g., list of RNTIs). The network may determine a (e.g., each) S-WTRU capability through S-WTRU reporting on the link between the Assistant WTRU and TRP.

Based on the first and second set of capabilities, the network may configure the Assistant and A-WTRU in an aggregated set, where one or more (e.g., each) may be identified with an aggregated set identifier (e.g., aggregatedUEpoolIndex) which may be associated with one or more of an SRS port group index, RNTI, TRP index (e.g., coresetPoolIndex), SRS resource set index, panel index.

For a (e.g., each) combination of S-WTRU and A-WTRU in an aggregation mode, the A-WTRU may indicate the supported capabilities for reception of a physical channel. For example, the A-WTRU may indicate that it supports rankAnchor and rankAssistant as separate ranks for reception of PDSCH on A-WTRU or S-WTRU, and rankAggregated when configured with reception on A-WTRU and S-WTRU. The A-WTRU may indicate that it supports a first codebook type in Mode A (e.g., Type-II), and a second codebook type (e.g., Type-I) in Mode B.

The A-WTRU may additionally report a time-based threshold to indicate the time required to switch between different aggregation modes (e.g., Mode A and Mode B). For example, the A-WTRU reports a capability timeDelayForAggregation which indicates the minimum time required by the A-WTRU to switch from Mode B to Mode A.

The A-WTRU may additionally report a time-based threshold to indicate the time required to process PDSCH as a function of the aggregation mode. For example, the A-WTRU reports a capability timeDelayForAggregatedPDSCH which indicates the minimum time required for the WTRU to decode a PDSCH when scheduled in Mode A or B.

The A-WTRU may report periods of validity for each set of capabilities with the associated parameters for the validity period. For example, the A-WTRU may indicate that its set of capabilities is (e.g., always) valid, and may indicate the S-WTRU's set of capabilities is periodically valid every T seconds. The A-WTRU may manage which S-WTRU devices are on/off for e.g., power saving. Such validity period information may be used by the network to determine the variation of the aggregation set capabilities over time (e.g., for resource allocation, scheduling assistance).

Based on the capability reporting, in a first option, the A-WTRU may determine to operate in either standalone reception from A-WTRU, standalone reception from S-WTRU, or aggregated reception from Anchor and S-WTRU based on an RRC configured aggregated mode of operation from the network. The network may semi-statically RRC reconfigure (e.g., or through MAC-CE) the mode of operation and aggregated set configuration (e.g., aggregatedUEpoolIndex and associated capabilities in the set) as a function of the A-WTRU's feedback. For example, the WTRU may determine that an aggregated mode of operation is associated with an RRC state (e.g., CONNECTED, IDLE, INACTIVE). Whenever the WTRU switches from one RRC state to another (e.g., CONNECTED to IDLE), the WTRU may switch to the associated aggregation mode (e.g., from Mode A to Mode B).

In a second option, the A-WTRU may dynamically manage its aggregation mode over time, and may trigger a CSI report or aggregation status report to indicate the change in aggregation mode to the network. The WTRU may monitor and perform channel measurements based on the RS configuration to determine the channel conditions over time that may affect the WTRU's choice to switch between the different aggregation modes. The WTRU may be configured with conditions that the WTRU may evaluate before determining to report a change in aggregation mode. One or more of the following conditions may be used: the A-WTRU's RSRP and/or S-WTRU's RSRP and/or the average RSRP of the WTRUs in the aggregated set is above a threshold, or the difference between an A-WTRU's RSRP and an Assistant WTRU's RSRP is greater than a threshold; the A-WTRU's channel quality towards the S-WTRU is below a threshold (e.g., channel quality on the non-3GPP link), or the difference is greater than a threshold; the distance between the A-WTRU and an S-WTRU (or the average distance of WTRUs in the aggregated set) is above a threshold, or the difference in distance is greater than a threshold; the battery power level of the A-WTRU and/or of an S-WTRU is above a threshold, or the difference in levels is above a threshold; the buffer status report (e.g. BSR) of the A-WTRU and/or of an S-WTRU is above a threshold; one or more of the CSI reporting quantities of the aggregation with Anchor and S-WTRU are greater than a threshold or greater than the CSI reporting quantities over standalone Anchor and/or S-WTRU reception (e.g., the rank or CQI in aggregated mode is greater than the rank in standalone mode); the resource allocation of the aggregation with Anchor and Assistant is greater than a threshold or greater than the resource allocation over standalone Anchor and/or S-WTRU reception (e.g., the A-WTRU determines that fewer time (e.g. slots, symbols, seconds) and/or frequency resources (e.g., RBs, carriers) are required to receive the PDSCH in aggregation mode compared to standalone mode); and/or the cross-layer interference (CLI) between A-WTRU and S-WTRU is above a threshold (e.g., the A-WTRU may determine that the interference between DL and UL transmissions (e.g., DL on A-WTRU, UL on S-WTRU) is greater than a threshold required to switch from standalone mode to aggregation mode). The WTRU may report IDC (In Device Coexistence) conditions related to the Base Station A-WTRU and S-WTRU radio-links in relation with the inter-A-WTRU and S-WTRU connection, which may result in reporting to BS specific WTRU assistance information (e.g., a pattern for DL and/or DL Rx/Tx conditions that did not cause mutual interference at the A-WTRU and S-WTRU level).

The conditions may be defined as part of a new CSI report configuration for aggregated more reporting, or may be defined as new triggers for reporting UE Assistance Information (UAI) or UE-Initiated Beam Reporting (UEIBR).

A CSI reporting configuration may be used. Configuration of sub-configurations associated with aggregation mode(s) and capability sets may be disclosed herein.

An A-WTRU may be configured with a CSI reporting configuration with one or more sub-configurations, where a (e.g., each) sub-configuration may correspond to aggregated or separate CSI reporting quantities such as PMI, RI, CSI-RS Resource Indicator (CRI) and/or CQI.

For example, in Mode A where the traffic is split into transmissions between TRP-A-WTRU and TRP-S-WTRU links, the A-WTRU and S-WTRU may be separately/jointly configured with one or more of the following sub-configurations.

In Mode A1, the A-WTRU may be configured with type 2 codebook to provide more resolutions for PMI reporting, and the S-WTRU may be configured with type 1 codebook with less resolution to report PMI. In another example, the A-WTRU may be configured with Type-I mode 2 codebook while the S-WTRU may be configured with Type-I mode 1 codebook to report PMI by RRC. The PMI in Mode 2 may be optimized at a sub-band level and may result in a better performance at the expense of an increased feedback overhead compared to Mode 1. Thus, in some scenarios where the channel of S-WTRU is better than A-WTRU, the A-WTRU may be configured with Type-I mode 1 codebook while the S-WTRU may be configured with Type-I mode 2 codebook to report PMI.

In Mode A1, the A-WTRU may be configured with a CRI along with N′ ports while the S-WTRU may be configured with a CRI along with N″ ports, where N′>N″to provide better PMI for the A-WTRU. However, in some scenarios where the S-WTRU can provide better PMI (e.g., there is blocking building in the direct link between TRP-A-WTRU and A-WTRU), N″>N′.

In Mode A1, the A-WTRU may report full CSI report quantities (e.g., PMI, CQI, RI and CRI) while the S-WTRU may report partial CSI report quantity/quantities (e.g., PMI, RI). In another example, the A-WTRU may report a partial CSI report quantity (e.g., PMI, CQI) while the S-WTRU may report different partial CSI report quantity/quantities (e.g., only RI)

In Mode A1, when a same codebook is configured for A-WTRU and S-WTRU, the A-WTRU may report a first subset of spatial-domain basis vectors and beam-combining coefficients, and S-WTRU may report a second subset of spatial-domain basis vectors and beam-combining coefficients for the private message where the basis vectors and coefficients are for example beam/precoding/PMI indices from Type-I/Type-II codebook such as i1, i2; and/or A-WTRU and S-WTRU may report a single subset of spatial-domain basis vectors, while A-WTRU and S-WTRU may report two separate subsets of beam-combining coefficients.

In Mode A2, where there is a joint scheduling (e.g., MU-MIMO type) of A-WTRU and S-WTRU, the A-WTRU may report (e.g., one) PMI (e.g., based on one codebook configuration configured for both A-WTRU and S-WTRU), (e.g., one) RI (across A-WTRU and S-WTRU), (e.g., one) CQI (across A-WTRU and S-WTRU) may report joint scheduling (e.g., MU-MIMO type) of anchor and assistant. The A-WTRU may combine one or more (e.g., two) PMIs (e.g., one from A-WTRU and one from S-WTRU) based on a co-phasing between the two PMIs. A-WTRU may combine two or more (e.g., two) PMIs (e.g., one from A-WTRU and one from S-WTRU) based on a co-phasing per (e.g., each) layer between the two or more (e.g., two) PMIs. This may increase the computational cost of A-WTRU to find the best co-phasing.

In mode A2, the A-WTRU may consider multiple S-WTRUs that exist around, then select a (e.g., only one) S-WTRU to report based on a maximum rank of one or more (e.g., all) S-WTRUs: A-WTRU may select S-WTRU whose rank is maximum among all candidates. If there are multiple candidates with maximum rank, the A-WTRU may perform one or more of the following: the A-WTRU may randomly select the S-WTRU; the A-WTRU may select the S-WTRU whose CQI is greater than a threshold; the A-WTRU may select the S-WTRU whose delay spread is minimum; and/or the A-WTRU may select the closest S-WTRU.

In another example, in Mode B where (e.g., all) traffic is sent (e.g., only) on the Anchor-TRP link or Assistant-TRP link which forwards it to the A-WTRU, the A-WTRU may report (e.g., only one) PMI (e.g., from Anchor/Assistant codebook configuration), (e.g., one) RI (e.g., from Anchor/Assistant), and/or (e.g., one) CQI (e.g., from Anchor/Assistant). The A-WTRU may determine to report anchor or assistant based on one or more of the following: the A-WTRU may compare two or more (e.g., two) RIs (one from anchor and one from assistant), then the A-WTRU may determine to report (e.g., only) the CSI quantities (e.g., PMI, CQI and RI) of whose RI is higher (e.g., if both ranks are equal, A-WTRU may determine to randomly select the report quantities of A-WTRU or S-WTRU); and/or the A-WTRU may compare one or more (e.g., two) RIs (e.g., one from anchor and one from assistant), then the A-WTRU may determine to report (e.g., only) the CSI quantities (e.g., PMI, CQI and RI) of whose CQI offers the better channel quality.

The A-WTRU may switch between anchor and assistant to report the CSI quantities. The A-WTRU may periodically compare both RIs and then (e.g., only) report CSI quantities of whose RI is higher in PUSCH. Since A-WTRU is monitoring both RIs over time, in a (e.g., each) scheduled PUSCH, the A-WTRU may determine to report CSI quantities of anchor or assistant. Alternatively, the A-WTRU may periodically compare both CQIs over frequency granularity and then (e.g., only) report CSI quantities of whose CQI offers better channel condition in PUSCH. Since the A-WTRU is monitoring both CQIs over frequency granularity, in a (e.g., each) scheduled PUSCH, the A-WTRU may determine to report CSI quantities of anchor or assistant.

The A-WTRU may be configured with a different set of rules for associating the capability sets (e.g., reporting quantities) to different BWPs in a channel bandwidth. The A-WTRU may be configured to measure/calculate different reporting quantities on different BWPs. The channel bandwidth may be split up to two BWPs, where A-WTRU may report based on one or more of following.

If Mode A1 is operated, in the first BWP, A-WTRU may report separate PMIs (e.g., different codebook configurations for A-WTRU or S-WTRU), separate RI and separate CQI for A-WTRU and S-WTRU. Then, in the second BWP, the A-WTRU may report separate PMIs with different codebook configurations in the first BWP.

If Mode A2 is operated, in the first BWP, A-WTRU may report a (e.g., one) PMI (one codebook configuration), a (e.g., one) RI and a (e.g., one) CQI for A-WTRU and S-WTRU. Then, in the second BWP, the A-WTRU may report separate PMIs with different method employed in the first BWP. For example, in the first BWP, the A-WTRU may report a (e.g., one) joint PMI based on a (e.g., one) co-phase between PMI of A-WTRU and PMI of S-WTRU. While in the second BWP, the A-WTRU may report a joint PMI based on a (e.g., one) co-phase per (e.g., each) layer between PMI of A-WTRU and PMI of S-WTRU.

If Mode B is operated, in the first BWP, the A-WTRU may report a (e.g., one) PMI, a (e.g., one) RI and a (e.g., one) CQI (e.g., only) for the A-WTRU. In the second BWP, the A-WTRU may report a (e.g., one) PMI, a (e.g., one) RI and a (e.g., one) CQI (e.g., only) for S-WTRU.

The A-WTRU may report a set of CSI quantities (e.g., PMI and RI) in the first BWP. In the second BWP, the A-WTRU may report another set of CSI quantities (e.g., PMI and CQI). In another example, the A-WTRU may report a set of CSI quantities (e.g., PMI, RI and CQI) in the first BWP. In the second BWP, the A-WTRU may report another set of CSI quantities (e.g., only RI).

One or more WTRU procedures to report CSI may be disclosed herein. A WTRU may receive a CSI reporting configuration with sub-configurations associated with the capability sets and aggregation modes of operation

In a first example, the A-WTRU may be configured to transmit on separate CSI reporting resources (e.g., PUCCH or PUSCH) as a function of an aggregation mode. Sub-configurations, reporting quantities, and/or number of CSI reports may be preconfigured as a function of the WTRU's supported aggregation mode and/or feedback. For example, if the A-WTRU supports one or more (e.g., two) modes of operation, then the WTRU may be configured with one or more (e.g., two) separate CSI reporting resources, and the WTRU may report the CSI contents for the different sub-configurations, and may include the contents in a (e.g., each) reporting resource associated with the aggregation mode corresponding to the sub-configuration. A (e.g., each) CSI report configuration ID may therefore be associated with an aggregated mode of operation (e.g., capability set). A (e.g., each) CSI reporting resource may (e.g., only) be configured with sub-configurations associated with its capability set.

In a second example, the A-WTRU may be configured with a (e.g., single) CSI reporting resource, which may include CSI reporting quantities from multiple sub-configurations. The A-WTRU may determine the CSI contents to report as a function of the indicated sub-configurations to report on the resource. A (e.g., single) CSI report may include multiple sub-configurations corresponding to different aggregation modes. In an alternative, a subset of reported sub-configurations may be WTRU determined. For example, the CSI report may consist of two or more (e.g., two) parts that are transmitted in separate times, with a first part (e.g., Part 1) before a second part (e.g., Part 2). In Part 1, the WTRU may report the Anchor-only CSI, and the WTRU may select one or more sub-configurations to report with an indicator. In Part 2, the WTRU may reports the CSI contents of the selected sub-configurations. In aggregated CSI reporting mode, the WTRU may report the time/frequency/phase offset between the reported CSIs of the sub-configurations (e.g., for coherent aggregated mode).

The A-WTRU may select the sub-configurations to report and may indicate the WTRU indices associated with the reporting quantities. The A-WTRU may indicate the ID of the WTRUs (e.g., RNTI, aggregatedUEpoolIndex) associated with the (e.g., each of the) reporting contents (e.g., reporting quantities such as CRI, PMI, RI, CQI) in the CSI report. For example, in standalone mode, the A-WTRU may report the CSI of the S-WTRU with the S-WTRU ID, or the CSI of the A-WTRU with the A-WTRU ID. Alternatively, the CSI report may be aperiodically triggered using a grant, where a field may be used to indicate the CSI report configuration that is triggered. The field may also indicate the ID of the WTRUs (e.g., aggregatedpoolsetIndex), a subset of sub-configurations, or an aggregation mode within the CSI report configuration. The grant may also indicate the index of the RS that is aperiodically triggered and associated with the AP-CSI report. If the RS is configured with one or more (e.g., two) measurement configurations, where a (e.g., each) measurement configuration is associated with a set of capabilities (e.g., one for A-WTRU and one for S-WTRU), then the aperiodic trigger may indicate which of the measurement configurations is triggered. For example, the trigger may indicate to the A-WTRU to measure the channel using the RS measurement configuration with the S-WTRU to determine the channel from the S-WTRU to the network, or using the RS measurement configuration with the A-WTRU to determine the channel from the A-WTRU to the network.

Resources for reporting CSI contents of an aggregated WTRU set may be disclosed. For aperiodic CSI reporting, the grant in the trigger may indicates or may be associated with a PUSCH resource, where the A-WTRU may include and transmit the CSI report. For periodic CSI reporting, the A-WTRU may use preconfigured periodic PUCCH resources to include and transmit the CSI report. A (e.g., each) CSI report or a (e.g., each) sub-configuration within the CSI report configuration may be configured with a priority index according to the aggregation mode of operation, and/or associated set of capabilities.

The A-WTRU may include the channel quality of the 3GPP link (e.g., RSRP) associated per S-WTRU or per determined WTRUs in the sub-configurations that are reported. Alternatively, the A-WTRU may be configured to report the link quality on the non-3GPP link (e.g., between the A-WTRU and the S-WTRU) based on a standardized format (e.g., mapped to a 3GPP RSRP), or based on a qualitative quantized level (e.g., 0 or 1 if the A-WTRU considers the link adequate or not for aggregation based on its measurement).

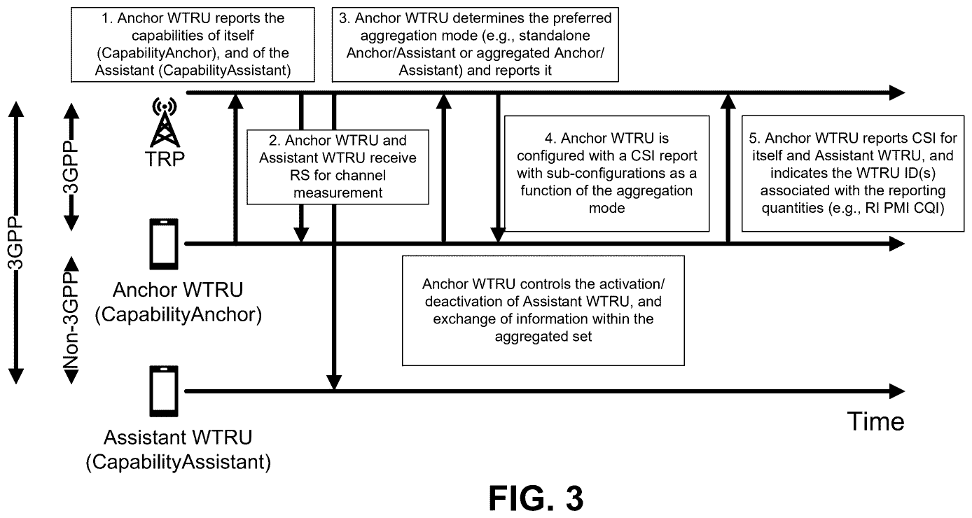

A CSI reporting procedure may be performed. FIG. 3 illustrates an example of CSI reporting for an aggregated set. FIG. 3 summarizes an embodiment of the solutions disclosed herein. The A-WTRU may report the capabilities of its device (CapabilityAnchor), and the devices of its S-WTRU (CapaiblityAssistant). For example, the A-WTRU may transmit, to the network network, a first set of capabilities associated with the A-WTRU and a second set of capabilities associated with a second WTRU (e.g., the S-WTRU). Based on these capabilities, the network may configure the A-WTRU with a RS to measure the channel, where different measurement configurations may be associated with the different capabilities (e.g., different BWPs, periodicity, carrier, etc.). For example, the A-WTRU may receive from the network, a reference signal (RS) configuration, wherein the RS configuration indicates one or more RS parameters for reception associated with the first set of capabilities and the second set of capabilities. The A-WTRU may receives the RS on the different measurement configurations, where the A-WTRU may receive the RS according to the first measurement configuration (e.g., the RS parameters) associated with CapabilityAnchor, and may use the S-WTRU to receive the RS according to the second measurement configuration (e.g., the RS parameters) associated with CapabilityAssistant. The A-WTRU may measure the channel and determine which aggregation mode of operation to operate in (e.g., based on the first and second sets of capabilities), and feed back this information to the network. Based on this feedback, the network may configure the WTRU with CSI reporting sub-configurations, where a (e.g., each) sub-configuration may be associated with an aggregation mode of operation with associated reporting quantities and/or a set of capabilities (e.g., the first or second sets of capabilities). For example, the A-WTRU may receive, from the network, one or more channel state information (CSI) reporting configurations, wherein each CSI reporting configuration of the one or more CSI reporting configurations is associated with one or more sub-configurations for aggregated CSI reporting. The WTRU may select, based on the first set of capabilities, the second set of capabilities, and the determined aggregation mode of operation, a CSI reporting sub-configuration. The A-WTRU may transmit the CSI report for the indicated sub-configurations. The WTRU may assist the network by selecting a subset of sub-configurations to report, and indicate in the CSI report which subset are reported. For example, the WTRU may transmit, to the network, a CSI report according to the selected CSI reporting sub-configuration, where the CSI report may include an indication of one or more indexes associated with the selected sub-configuration and an index of at least one of the first set of capabilities and the second set of capabilities. The WTRU may receive, from the network, a grant scheduling a physical downlink shared channel (PDSCH) transmission, where the grant may indicate the determined aggregation mode of operation and a resource allocation associated with the determined aggregation mode of operation.

The A-WTRU may determine to split CSI reporting between itself and the S-WTRU based on the CSI report resource allocation. If the WTRU is scheduled to transmit two or more (e.g., two) different CSI reports in the same slot (e.g., an aperiodically triggered CSI report and a periodic CSI report), then the WTRU may transmit the CSI report with the highest priority index, or alternatively the CSI report associated with the highest priority sub-configurations. The WTRU may include the CSI reporting quantity associated with the highest priority index in the CSI report, and may drop the other reporting quantities.

Alternatively, the CSI payload size of the A-WTRU may not fit in the uplink resources (e.g., PUCCH or PUSCH resources assigned to the A-WTRU for reporting of the anchor CSI report). Therefore, the A-WTRU may omit a portion of the payload in order to fit it into the assigned uplink resources.

The uplink resources (e.g., PUCCH or PUSCH resources assigned to the S-WTRU for reporting of the CSI) may fit more bits than the payload size of the S-WTRU CSI report. Therefore, the S-WTRU may perform bit-padding.

Instead of performing bit-padding, the A-WTRU may send the CSI portion intended for omission to the S-WTRU using the non-3GPP link. Instead of bit-padding, the S-WTRU may use the additional resources to transmit a portion of the anchor CSI report to the gNB. For example, one or more of the following may apply.

The CSI of the A-WTRU and the S-WTRU may be denoted by anchor_CSI (A-CSI) and assistant_CSI (S-CSI) respectively. The A-CSI and S-CSI may include indications for A-RI and S-RI, respectively. The payload sizes of A-CSI and S-CSI may be A-payload and S-payload, respectively. The uplink resources (e.g., PUCCH or PUSCH resources for reporting the A-CSI and S-CSI) may be denoted by A-PUCCH and S-PUCCH, respectively. The A-payload may not fit into A-PUCCH. The S-PUCCH may fit a higher payload than the S-Payload. The A-WTRU may send a portion of A-Payload to the S-WTRU using a non-3GPP link. The A-WTRU may send a CSI report that includes indications for the A-Payload and no indications for the omitted part. The S-WTRU may send a CSI report that includes indications for the S-Payload and a portion of A-Payload sent by A-WTRU to S-WTRU. The A-WTRU and/or the S-WTRU may send an indication that indicates the omitted/extra part. The A-WTRU and/or the S-WTRU may not send any indication indicating the omitted/extra part as A-RI and S-RI, and A-PUCCH and S-PUCCH may be implicit indications of the of the payload part omitted from A-Payload or the payload part of A-Payload sent by S-WTRU.

WTRU procedure(s) for PDSCH reception may be performed. An A-WTRU may receive an indication (e.g., for semi-dynamic mode switching), for example via a MAC-CE, selecting an aggregation mode as at least one of described Mode A, A1, A2, B, B1, and B2. The indication (e.g., for semi-dynamic mode switching) may be associated with one or more time-domain parameters determining at least a starting time and/or an ending time of applying the indicated aggregation mode. For example, the A-WTRU may receive the indication selecting Mode A1 via a MAC-CE message, where the WTRU may determine based on the received indication that at time T1 (e.g., after receiving the indication) the Mode A1 starts operation and/or at time T2 (later than T1) the Mode A1 ends operation. At time T2, the A-WTRU may change (e.g., switch) the aggregation mode to the one used before T1 or to a fallback mode based on a pre-defined or pre-configured rule to determine an aggregation mode as a fallback mode.

The A-WTRU may receive an indication (e.g., for dynamic mode switching), for example via a DCI, selecting an aggregation mode as at least one of described Mode A, A1, A2, B, B1, and B2. The indication (e.g., for dynamic mode switching) may be associated with one or more time-domain parameters determining at least a starting time and/or an ending time of applying the indicated aggregation mode. For example, the A-WTRU may receive the indication selecting Mode A1 via the DCI (e.g., a separate DCI, a group-common DCI, etc.), where the WTRU may determine based on the received indication that at time T1 (e.g., after receiving the indication) the Mode A1 starts to operate and/or at time T2 (e.g., later than T1) the Mode A1 ends to operate. At time T2, the A-WTRU may change (e.g., switch) the aggregation mode to the one used before T1 or to a fallback mode based on a pre-defined or pre-configured rule to determine an aggregation mode as a fallback mode.

The indication by the MAC-CE and/or DCI may explicitly indicate information on T1 and/or T2, or may indicate a time offset parameter to determine when to start applying the indicated aggregation mode. For example, the A-WTRU may start applying the indicated aggregation mode at a time determined based on the time offset parameter after receiving the MAC-CE and/or DCI. The indication by the MAC-CE and/or DCI may (e.g., further) indicate how long the indicated aggregation mode is to be applied (e.g., based on a number of slots, frames, time units) or may indicate a number of DL data receptions (e.g., reception occasions) applicable for the indicated aggregation mode (e.g., as a “multi-shot” indication on the number of applicable occasions). The A-WTRU may determine that at least one of DCI fields in a DCI (e.g., scheduling a DL data, e.g., PDSCH) during the time is reinterpreted to correspond to the indicated aggregation mode (e.g., Mode A1, so that the DCI may comprise only DCI field(s) relevant to A-WTRU's DL data reception based on the independent scheduling manner by the Mode A1). In an example, before time T1 (e.g., if Mode A2 was used), a DCI scheduling a DL data may comprise both resource allocation fields (e.g., one for A-WTRU and another for S-WTRU), and at time T1, the A-WTRU may determine a DCI scheduling a DL data may comprise (e.g., only) resource allocation field for A-WTRU, where the DCI field size may be reduced accordingly (e.g., compared with that before time T1), which may provide benefits in terms of saving DCI overhead in control channel.

The A-WTRU may receive an indication (e.g., for dynamic mode selection), for example via a DCI, selecting an aggregation mode as at least one of described Mode A, A1, A2, B, B1, and B2, where the selected aggregation mode may be applicable (e.g., only) for a PDSCH, scheduled by the DCI (e.g., as a “one-time” mode selection by the same DCI which schedules a PDSCH and indicates the selected aggregation mode for the scheduled PDSCH).

Operation under Mode A1 may be performed. When Mode A1 starts to operate (e.g., at time T1, indicated by the MAC-CE and/or DCI), the A-WTRU may receive a DCI (e.g., scheduling a DL data) comprising at least a first DCI field indicating a resource allocation for the A-WTRU, a second DCI field indicating DMRS related information including a scheduled number of layers L1 (e.g., L1=1 or 2, if A-WTRU supports up to 2 ranks (layers)), corresponding DMRS port(s), and/or DMRS sequency related parameter(s), a third DCI field indicating an MCS value for the A-WTRU (e.g., corresponding to the L1 layers), and/or a fourth DCI field indicating a TCI-state(s) to be used for receiving the scheduled PDSCH (e.g., if an individual beam indication scheme is configured/used) or for receiving next PDSCH receptions at least (e.g., if a unified TCI framework is configured/used). The A-WTRU may reinterpret (e.g., starting at time T1) the DCI to be comprising at least one of the first, second, third, and fourth DCI fields, different from a DCI (of the same type, e.g., DL-scheduling DCI) received before T1 (e.g., having a different DCI field size due to having other DCI fields relevant to S-WTRU if a different aggregation mode had been used).

Based on the received DCI, the A-WTRU may receive a first part of the scheduled PDSCH corresponding to the L1 layers. An S-WTRU may receive a second part of the scheduled PDSCH (e.g., scheduled by a separate DCI directly received at the S-WTRU), and the A-WTRU may receive information based on the second part of the scheduled PDSCH from the S-WTRU (e.g., via a non-3GPP method). The A-WTRU may receive the scheduled PDSCH, based on (e.g., by combining) the first part and the second part. The A-WTRU may transmit an ACK to a base station (BS) if the scheduled PDSCH is successfully decoded.

Operation under Mode A2 may be performed. When Mode A2 starts to operate (e.g., at time T1, indicated by the MAC-CE and/or DCI), the A-WTRU may receive a DCI (scheduling a DL data) comprising at least: a first DCI field indicating a resource allocation for the A-WTRU; a second DCI field indicating DMRS related information including a scheduled number of layers L1, corresponding DMRS port(s), and/or DMRS sequency related parameter(s); a third DCI field indicating a first MCS value for the A-WTRU; a fourth DCI field indicating a first TCI-state(s) for the A-WTRU; a fifth DCI field indicating a resource allocation for the S-WTRU; a sixth DCI field indicating DMRS related information including a scheduled number of layers L2, corresponding DMRS port(s), and/or DMRS sequency related parameter(s); a seventh DCI field indicating a second MCS value for the S-WTRU; and/or an eighth DCI field indicating a second TCI-state(s) for the S-WTRU.

The A-WTRU may reinterpret (e.g., starting at time T1) the DCI to be comprising at least one of the first, second, . . . , eighth DCI fields, different from a DCI (of the same type, e.g., DL-scheduling DCI) received before T1 (e.g., having a different DCI field size).

Based on the received DCI, the A-WTRU may receive a first part of the scheduled PDSCH corresponding to the L1 layers by using the first, second, third, and/or fourth DCI fields that are applicable for the A-WTRU (e.g., not the S-WTRU). This may mean the A-WTRU may ignore (e.g., disregard) the other fifth, sixth, seventh, and eighth DCI fields. In another example, the A-WTRU may transmit information based on at least one of the fifth, sixth, seventh, and eighth DCI fields directly to the S-WTRU, so that the S-WTRU may receive a second part of the scheduled PDSCH corresponding to L2 layers. The S-WTRU may receive (e.g., directly) the DCI, where the S-WTRU may receive a second part of the scheduled PDSCH corresponding to the L2 layers by using the fifth, sixth, seventh, and/or eighth DCI fields that are applicable for the S-WTRU. This may mean the S-WTRU may ignore (e.g., disregard) the other first, second, third, and fourth DCI fields.

The A-WTRU may receive information based on the second part of the scheduled PDSCH from the S-WTRU (e.g., via a non-3GPP method). The A-WTRU may receive the scheduled PDSCH, based on (e.g., by combining) the first part and the second part. The A-WTRU may transmit an ACK to a base station (BS) if the scheduled PDSCH is successfully decoded.

Operation under Mode B1 may be performed. When Mode B1 starts to operate (e.g., at time T1, indicated by the MAC-CE and/or DCI), the A-WTRU may receive a DCI (e.g., scheduling a DL data) comprising at least a first DCI field indicating a resource allocation for the A-WTRU, a second DCI field indicating DMRS related information including a scheduled number of layers L1 (e.g., L1=1 or 2, if A-WTRU supports up to 2 ranks (layers)), corresponding DMRS port(s), and/or DMRS sequency related parameter(s), a third DCI field indicating an MCS value for the A-WTRU (e.g., corresponding to the L1 layers), and/or a fourth DCI field indicating a TCI-state(s) to be used for receiving the scheduled PDSCH (e.g., if an individual beam indication scheme is configured/used) or for receiving next PDSCH receptions at least (e.g., if a unified TCI framework is configured/used). The A-WTRU may reinterpret (e.g., starting at time T1) the DCI to be comprising at least one of the first, second, third, and fourth DCI fields, different from a DCI (of the same type, e.g., DL-scheduling DCI) received before T1 (e.g., having a different DCI field size due to having other DCI fields relevant to S-WTRU if a different aggregation mode had been used).

Based on the received DCI, the A-WTRU may receive a first part of the scheduled PDSCH corresponding to the L1 layers. An S-WTRU may receive a second part of the scheduled PDSCH (e.g., scheduled by a separate DCI directly received at the S-WTRU, where the separate DCI may schedule the same data as for the A-WTRU but at least with a different spatial-domain related parameter), and the A-WTRU may receive information based on the second part of the scheduled PDSCH from the S-WTRU (e.g., via a non-3GPP method). The A-WTRU may receive the scheduled PDSCH, based on (e.g., by combining) the first part and the second part. The A-WTRU may transmit an ACK to a base station (BS) if the scheduled PDSCH is successfully decoded.

Operation under Mode B2 may be performed. When Mode B2 starts to operate (e.g., at time T1, indicated by the MAC-CE and/or DCI), the A-WTRU may receive a DCI (scheduling a DL data) comprising one or more of: a first DCI field indicating a resource allocation for the A-WTRU; a second DCI field indicating DMRS related information including a scheduled number of layers L1, corresponding DMRS port(s), and/or DMRS sequency related parameter(s); a third DCI field indicating a first MCS value for the A-WTRU; a fourth DCI field indicating a first TCI-state(s) for the A-WTRU; a fifth DCI field indicating a resource allocation for the S-WTRU; a sixth DCI field indicating DMRS related information including a scheduled number of layers L2, corresponding DMRS port(s), and/or DMRS sequency related parameter(s); a seventh DCI field indicating a second MCS value for the S-WTRU; and/or an eighth DCI field indicating a second TCI-state(s) for the S-WTRU.

Based on the Mode B2, the fifth, sixth, and/or seventh DCI field may be absent in the DCI, which means such scheduling related information based on these absent field(s) may be common between the A-WTRU and S-WTRU so that S-WTRU may read the same common information as the A-WTRU (e.g., at least except the eighth DCI field dedicated to the S-WTRU).

The A-WTRU may reinterpret (e.g., starting at time T1) the DCI to be comprising at least one of the first, second, . . . , eighth DCI fields, different from a DCI (of the same type, e.g., DL-scheduling DCI) received before T1 (e.g., having a different DCI field size).

Based on the received DCI, the A-WTRU may receive a first part of the scheduled PDSCH corresponding to the L1 layers by using the first, second, third, and/or fourth DCI fields that are applicable for the A-WTRU (e.g., not the S-WTRU). This may mean the A-WTRU may ignore (e.g., disregard) the other fifth, sixth, seventh, and eighth DCI fields. In another example, the A-WTRU may transmit information based on at least one of the fifth, sixth, seventh, and/or eighth DCI fields directly to the S-WTRU, so that the S-WTRU may receive a second part of the scheduled PDSCH corresponding to L2 layers. The S-WTRU may receive (e.g., directly) the DCI where the S-WTRU may receive a second part of the scheduled PDSCH corresponding to the L2 layers by using the fifth, sixth, seventh, and/or eighth DCI fields that are applicable for the S-WTRU. This may mean the S-WTRU may ignore (e.g., disregard) the other first, second, third, and fourth DCI fields.

The A-WTRU may receive information based on the second part of the scheduled PDSCH from the S-WTRU (e.g., via a non-3GPP method). The A-WTRU may receive the scheduled PDSCH, based on (e.g., by combining) the first part and the second part. The A-WTRU may transmit an ACK to a base station (BS) if the scheduled PDSCH is successfully decoded.

One or more fallback procedures may be performed. The A-WTRU may be triggered to perform a fallback procedure based on one or more triggers. One or more of the following fallback procedures may be executed by the A-WTRU and/or by the S-WTRUs in the aggregated set, where a (e.g., each) procedure may be associated with respective triggers.

Fallback for PDSCH's default TCI/beam state determination may be performed. If the time delay between the grant (e.g., DCI) and the physical channel reception (e.g., PDSCH) is less than a threshold (e.g., timeDelayForAggregation, timeDurationForQCL), the A-WTRU may fall back to a default aggregation mode of operation for receiving the physical channel. The WTRU may fall back from a joint reception between Anchor and S-WTRU to a standalone reception from (e.g., only) one of the A- or S-WTRU. The WTRU may not expect to be scheduled with an S-WTRU within the threshold. Alternatively, the WTRU may expect to be scheduled with a subset of S-WTRUs from the aggregation set, where the WTRU may determine the subset based on a preconfigured set of WTRU IDs for fallback mode, or based on a default rule to determine the S-WTRU (e.g., the S-WTRU with the lowest/highest capability set, and/or the lowest WTRU ID assigned to a capability set). Alternatively, if the A-WTRU or an S-WTRU enters Beam Failure Recovery (BFR), the A-WTRU may fallback to a default reception, and the A-WTRU may determine that it expects to be scheduled (e.g., only) in an aggregation mode of operation without WTRUs that are in BFR.

The A-WTRU may determine a default TCI state for PDSCH reception in the fallback mode. The fallback mode may be associated with a default aggregation mode of operation and its associated TCI state configuration. For example, in standalone reception mode, the WTRU may receive PDSCH using a first TCI state, and in aggregated reception mode using a second TCI state (e.g., or a pair of TCI states). The PDCCH carrying the grant may be associated with a (e.g., one) aggregated reception mode with a TCI associated with the CORESET carrying the PDCCH, and the WTRU may determine to receive the PDSCH with the same TCI and/or aggregation mode from the PDCCH carrying the grant. The A-WTRU may use the lowest CORESET ID amongst the CORESETs monitored by WTRUs in the aggregation set to determine the default TCI state for PDSCH reception.

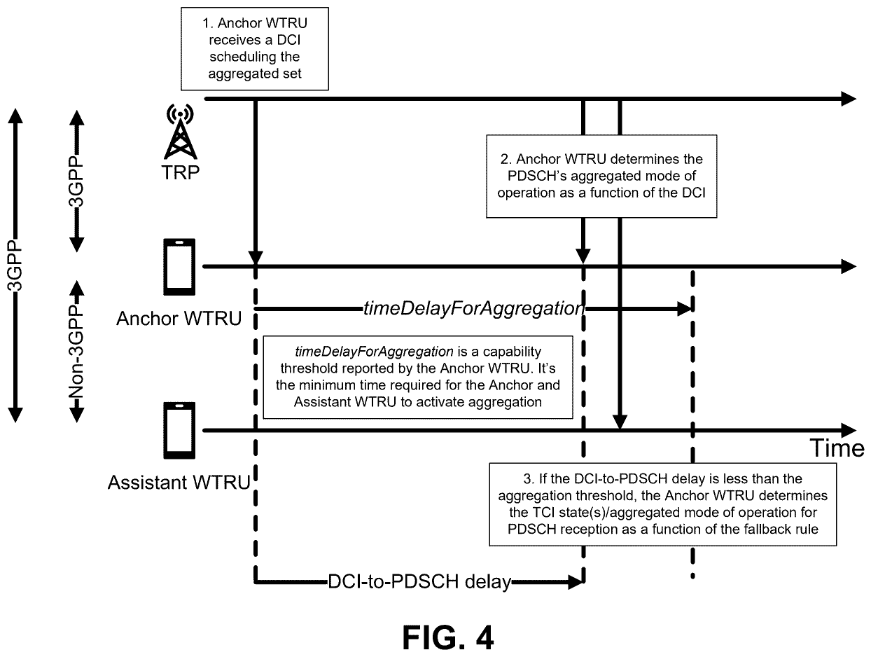

FIG. 4 illustrates an example of a WTRU's fallback procedure for PDSCH reception. FIG. 4 shows an exemplary timeline of the fallback procedure for a default aggregation mode of operation and TCI determination. The A-WTRU may receive the grant scheduling a PDSCH at a later time given by the DCI-to-PDSCH delay. Based on the A-WTRU's reported capability threshold of timeDelayForAggregation, the A-WTRU may determine the aggregation mode of operation and TCI state to receive the PDSCH as a function of the threshold being greater/smaller than the DCI-to-PDSCH delay.

The A-WTRU may fall back to a different aggregation mode/TCI state based on the state of the HARQ process feedback associated with the PDSCH. For example, if the A-WTRU fails to decode the PDSCH, it may send an ACK or NACK on a resource (e.g., PUCCH) scheduled with a time offset of at least timeDelayForAggregatedPDSCH after the PDSCH. The WTRU may fall back to a first default aggregation mode of operation/TCI if it sends an ACK, and to a different default aggregation mode of operation/TCI if it sends a NACK.

Fallback based on DCI format and/or contents of DCI may be performed. The WTRU may determine the default aggregation mode to receive a physical channel based on the aggregation mode associated with the DCI format[1] carrying the grant scheduling the physical channel. For example, if the WTRU receives a DCI format 1_0, the WTRU may determine that it should receive the scheduled PDSCH using (e.g., only) the A-WTRU, and otherwise (e.g., DCI format 1_1) the WTRU may receive the scheduled PDSCH using the aggregation of Anchor and S-WTRU. The WTRU may determine the fields of the DCI contents based on the determined aggregation mode of operation. For example, the CORESET may be preconfigured with an aggregation mode and the WTRU may assume that DCIs transmitted on a PDCCH candidate on the CORESET may be received with the associated aggregation mode, and the fields of the DCI may correspond to the scheduling information (e.g., resource allocation) necessary for the associated aggregation mode. Instead of DCI format, the scrambling identity (e.g., RNTI) of the DCI may be associated with an aggregation mode of operation.

The A-WTRU may fall back to a different aggregation mode/TCI state as a function of the contents of the grant. Different modes of aggregation may be associated with the values/contents of the fields in the grant (e.g., number of repetitions, TDRA, FDRA, NDI, etc.).

Fallback CSI reporting procedure(s) may be performed. The A-WTRU may initiate a fallback procedure for the CSI reporting procedure, where the A-WTRU may determine to report CSI for a default subset of the CSI reporting sub-configurations and/or a default aggregation reception mode for PDSCH. For example, the WTRU may be configured with a CSI reporting configuration with one or more (e.g., two) sub-configurations, where a first sub-configuration (e.g., sub-configuration1) is for standalone A-WTRU, and a second sub-configuration (e.g., sub-configuration2) is for aggregation mode of Anchor and S-WTRU, and the WTRU may indicate to report CSI for either sub-configuration1, sub-configuration2, or both sub-configuration1 and sub-configuration2. In fallback mode, the WTRU may determine that (e.g., only) sub-configuration1 may be reported. The A-WTRU may determine to initiate the fallback procedure based on the measure channel quality of S-WTRUs in the aggregation set (e.g., RSRP, SNR, SINR), where the channel quality may be measured between the network and the WTRUs in the aggregation set (e.g., on the 3GPP interface), or signal quality between WTRUs within the aggregation set (e.g., on the non-3GPP interface). Alternatively, the A-WTRU may consider other triggering conditions (e.g., distance between WTRUs in the aggregation set, distance between WTRUs in the aggregation set and the network, RRC state of WTRUs in the aggregation set, number of WTRUs in the aggregation set) to initiate a fallback CSI reporting procedure.

To initiate a fallback CSI reporting procedure, the A-WTRU may transmit a feedback report which may include a field where the A-WTRU indicates if it is in fallback mode, and may indicate the subset of capabilities or Assistant/A-WTRUs that may be scheduled in fallback mode. The feedback report may be one of a UAI, a UEIBR (e.g., as defined in Release 19 with WTRU-initiated reporting of beam-related information based on triggering conditions), CSI report, MAC-CE, UCI, etc.

The A-WTRU may initiate a fallback procedure if IDC (In Device Coexistence) conditions related to the Base Station A-WTRU and S-WTRU radio-links in relation with the inter-A-WTRU and S-WTRU connection occur. The WTRU may report this situation, for example through an RRC message. The WTRU may indicate in the UE assistance information the reason for the coexistence issue, the interference direction (e.g., DL or/and UL), the interferer, and may suggest a pattern for traffic that may resolve the interference cause. Alternatively, the WTRU may suggest the supported aggregation mode (e.g., A or B) under this situation. This may lead to a fallback between aggregation mode to normal Rx/Tx for A-WTRU, or an Aggregation Mode change and traffic adaptation if a Rx/Tx pattern is reported by the WTRU in its assistance data.

1. A wireless transmit/receive unit (WTRU) comprising a processor configured to:
transmit, to a network, a first set of capabilities associated with the WTRU and a second set of capabilities associated with a second WTRU;
receive, from the network, a reference signal (RS) configuration, wherein the RS configuration indicates one or more RS parameters for reception associated with the first set of capabilities and the second set of capabilities;
receive the RS based on the received RS parameters;
determine, based on the first set of capabilities and the second set of capabilities, an aggregation mode of operation;
receive, from the network, one or more channel state information (CSI) reporting configurations, wherein each CSI reporting configuration of the one or more CSI reporting configurations is associated with one or more sub-configurations for aggregated CSI reporting;
select, based on the first set of capabilities, the second set of capabilities, and the determined aggregation mode of operation, a CSI reporting sub-configuration; and
transmit, to the network, a CSI report according to the selected CSI reporting sub-configuration, wherein the CSI report comprises an indication of one or more indexes associated with the selected sub-configuration and an index of at least one of the first set of capabilities and the second set of capabilities.

2. The WTRU of claim 1, wherein each sub-configuration of the one or more sub-configurations is associated with at least one of the first set of capabilities and the second set of capabilities.

3. The WTRU of claim 1, wherein each sub-configuration of the one or more sub-configurations indicates one or more reporting quantities associated with at least one of the first set of capabilities and the second set of capabilities.

4. The WTRU of claim 1, wherein the WTRU is an anchor WTRU, and wherein the second WTRU is an assistant WTRU.

5. The WTRU of claim 1, wherein the processor is further configured to receive, from the network, a grant scheduling a physical downlink shared channel (PDSCH) transmission, wherein the grant indicates the determined aggregation mode of operation and a resource allocation associated with the determined aggregation mode of operation.

6. The WTRU of claim 1, wherein the aggregation mode of operation is a first aggregation mode of operation, and wherein the processor is further configured to:
select a second aggregation mode of operation; and
perform a fallback procedure.

7. The WTRU of claim 6, wherein the processor being configured to perform the fallback procedure comprises the processor being configured to:
determine a default subset of the one or more sub-configurations; and
transmit, to the network, a CSI report associated with the default subset.

8. The WTRU of claim 6, wherein the processor being configured to perform the fallback procedure comprises the processor being configured to determine a default aggregation reception mode for PDSCH.

9. The WTRU of claim 6, wherein the processor is configured to select the second aggregation mode of operation based on one or more of a channel measurement quality or an aggregation timing threshold.

10. A method implemented in a wireless transmit/receive unit (WTRU), the method comprising:
transmitting, to a network, a first set of capabilities associated with the WTRU and a second set of capabilities associated with a second WTRU;
receiving, from the network, a reference signal (RS) configuration, wherein the RS configuration indicates one or more RS parameters for reception associated with the first set of capabilities and the second set of capabilities;
receiving the RS based on the received RS parameters;
determining, based on the first set of capabilities and the second set of capabilities, an aggregation mode of operation;
receiving, from the network, one or more channel state information (CSI) reporting configurations, wherein each CSI reporting configuration of the one or more CSI reporting configurations is associated with one or more sub-configurations for aggregated CSI reporting;
selecting, based on the first set of capabilities, the second set of capabilities, and the determined aggregation mode of operation, a CSI reporting sub-configuration; and
transmitting, to the network, a CSI report according to the selected CSI reporting sub-configuration, wherein the CSI report comprises an indication of one or more indexes associated with the selected sub-configuration and an index of at least one of the first set of capabilities and the second set of capabilities.

11. The method of claim 10, wherein each sub-configuration of the one or more sub-configurations is associated with at least one of the first set of capabilities and the second set of capabilities.

12. The method of claim 10, wherein each sub-configuration of the one or more sub-configurations indicates one or more reporting quantities associated with at least one of the first set of capabilities and the second set of capabilities.

13. The method of claim 10, wherein the WTRU is an anchor WTRU, and wherein the second WTRU is an assistant WTRU.

14. The method of claim 10, further comprising receiving, from the network, a grant scheduling a physical downlink shared channel (PDSCH) transmission, wherein the grant indicates the determined aggregation mode of operation and a resource allocation associated with the determined aggregation mode of operation.

15. The method of claim 10, wherein the aggregation mode of operation is a first aggregation mode of operation, and wherein method further comprises:
selecting a second aggregation mode of operation; and
performing a fallback procedure.

16. The method of claim 15, wherein performing the fallback procedure comprises:
determining a default subset of the one or more sub-configurations; and
transmitting, to the network, a CSI report associated with the default subset.

17. The method of claim 15, wherein performing the fallback procedure comprises determining a default aggregation reception mode for PDSCH.

18. The method of claim 15, wherein the second aggregation mode of operation is selected based on one or more of a channel measurement quality or an aggregation timing threshold.
